(19) United States
(12) Patent Application Publication
(10) Pub. No.: US 2007/0133784 A1
(43) Pub. Date: Jun. 14, 2007

(54) Rapid dialling

(76) Inventor: Ulf Jarredal, Sundbyberg (SE)

Correspondence Address: ERICSSON INC., 6300 LEGACY DRIVE, M/S EVR 1-C-11, PLANO, TX, 75024, US

(21) Appl. No.: 10/599,093

(22) PCT Filed: Mar. 19, 2004
(86) PCT No.: PCT/SE04/00414

§ 371 Date: Feb. 23, 2007

(51) Int. Cl. H04M 1/00; H04M 3/00

(52) U.S. Cl. 379/355.05

(57) ABSTRACT

The present invention relates to methods and arrangements for rapid dialing in a telecommunication system that requires an indication of a B-number termination to establish a connection. The system is communicating with a telephone set (POTS) without ability to indicate such termination. A B-number is dialed using said telephone set. A B-value composed of the so far dialed digits is compared with a list of records stored in a database in the system. Conformity is found between the composed B-value and a record in said list, which found record points to a numeral representing the total number of digits in the complete B-number.

### TECHNICAL FIELD OF THE INVENTION

The present invention relates to methods and arrangements for rapid dialling in a telecommunication system that requires an indication of a B-number termination to establish a connection and when a telephone set without ability to indicate such termination is used in the system.

### DESCRIPTION OF RELATED ART

Telephony networks of today are based on several generations of different technology, the traditional PSTN network and the new generations of wireless and packet based telephony e.g. GSM, 3G, VOIP, SIP and H.323.

The address model of the phone numbers (to dial any subscribers on the PSTN network) is normally from 5 up to 13 digits. The amount of digits are depending on several parameters e.g. if the call is short/long distance or domestic/international.

A call initiative in a PSTN network begins with that an A-user is lifting a handset (off-hook) and gets a dial-tone indicating to the user to start dialling a B-number. Each digit received by a call control function is immediately analysed for routing. When the network has received all digits, a connection is established. Redundant digits dialled by the user after the complete number is received are ignored. The call initiative is normally not terminated by pressing a “CALL” or “SEND” button.

A call initiative in a new generation of wireless and packet based telephony is started by pressing buttons to generate a B-number and finally terminated by pressing for example a “CALL” button

When a traditional PSTN telephone set POTS is used as a handset in a new generation GSM/3G/SIP network, the signalling (for example DTMF-signalling and Ethernet-signalling) between the telephone set and the network is decoded/encoded in customer premises equipment. Communication over different systems and standards is disclosed in the US patent US 2003 0109271

A problem arises however when the A-subscriber using the POTS-handset has pressed all digits of the B-number but is unable to terminate the call initiative by pressing a “CALL” or “SEND” button. It will be difficult for the GSM/3G/SIP network to know when all digits of the B-number have been pressed and a connection is to be established.

A solution for this problem could be to have one database for all the phone-numbers in the world and when a number is found, the connection is established. This is however hardly a realistic solution.

Another and more natural solution to terminate the call-initiative without pressing any “CALL”-button is to define a “Call-on-timeout” function. The “Call-on-timeout” establish a connection after a predefined time from the last pressed digit has expired. The predefined time could be for example 10 seconds. The consequence and problem of this is that the user must wait 10 seconds before the call-initiative is started. This might be frustrating to involved parties which is an unwanted situation.

Yet another alternative solution is that the A-subscriber must press an emulated button when the whole B-number has been dialled, for example the #-button which has been defined as an emulated “SEND” button. This solution has other disadvantages since the A-subscriber must learn how to act in different situations.

### SUMMARY OF THE INVENTION

The present invention solves a problem related to interaction between telecommunication technologies when one technology requires a measure that can't be supplied by the other technology. More specifically, such a problem arises for example when a telephone set without possibility to indicate termination of a dialled B-number is communicating with a system that requires such indication in order to establish a connection to a B-subsriber.

Using the fact that a B-numbers total length can be identified before the whole number has been dialled, by analysing the so far dialled digits, solves the problem according to the invention.

More in detail the problem is solved by a method that comprises the following steps:
A B-number is dialed using a telephone set without ability to indicate termination of the dialled B-number.
A B-value is composed of the so far dialed digits and compared with a list of reference values stored in a database.
Conformity is found between the composed B-value and a reference value in said list. The found reference value points to a numeral that represents the total number of digits in the complete B-number.

A purpose with the invention is to interact different telecommunication technologies where one technology requires a measure that can't be supplied by the other technology.

An advantage of the invention is that the average time for a call-initiative is speeded up.

Another advantage is that the general quality of service for an A-subscriber is increased.

The invention will now be described more in detail with the aid of preferred embodiments in connection with the enclosed drawings.

### BRIEF DESCRIPTION OF THE DRAWINGS

FIG. 1 shows a block schematic illustration according to a first and second embodiment of the invention. The figure shows a mobile-at-home telecommunication system in which a telephone set without ability to indicate termination of a B-number is used.

FIG. 2 discloses a database with records such as B-numbers, Minimum of Relevant Digits—MRD, Total Number of Digits—TND.

FIG. 3 discloses a flowchart illustrating a method for rapid dialling in a telecommunication system according to the second embodiment of the invention.

FIG. 4 shows a block schematic illustration of a third embodiment of the invention.

### DETAILED DESCRIPTION OF EMBODIMENTS

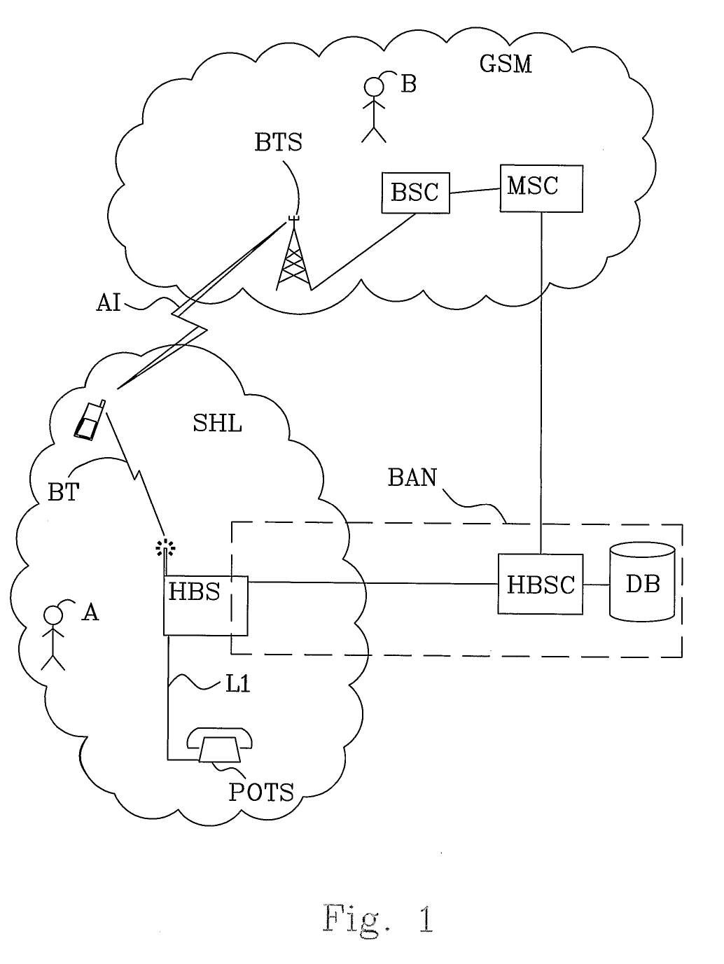

FIG. 1 shows a telecommunication system comprising a mobile-at-home system associated with a GSM network. The GSM network comprises a Mobile Service Switching Centre MSC, a Base Station Controller BSC and a Base Transceiver Station BTS. The mobile-at-home system comprises Customer Premises Equipment in the form of a Home Base Station HBS located within a subscriber's home location SHL. The HBS communicates with the MSC via a Home Base Station Controller HBSC in a Broadband Access Network BAN. A database DB is located in the BAN and is connected to the HBSC.

In a mobile-at-home system the general idea is that a user shall be able to use his outdoors e.g. GSM phone also when he is indoor in his home location SHL. Outdoor, the GSM phone locks to the Base Transceiver Station BTS via an air-interface AI while at home the GSM phone locks to the home base station HBS via a blue-tooth interface BT. The user is hereby able to switch between two types of access networks. At the home location the communication between the GSM phone and the GSM network takes place via the Broadband Access Network BAN while outdoors the communication takes place via the GSM transmission network. Within the home location, the HBS acts as an interface between the GSM telephone set and the Home Base Station Controller HBSC. The user might however prefer to use his Broadband Access Network not only when using the GSM phone but also when using an ordinary phone POTS located in the home, instead of using a more costly public network. To be able to do this the POTS must be connected to the Home Base Station HBS via e.g. wires, and the POTS must be configured in the HBS. The signalling between the POTS and the HBS is Dial Tone Multi-frequency DTMF signalling and control signalling hereby has to be mapped and generated in the HBS, between the POTS handset and the Broadband Access Network BAN. As the POTS handset in this example lacks a “CALL” button like the one a GSM phone has, a dialled B-number cannot be properly terminated. An indication of termination is required by the Home Base Station Controller HBSC to know when all digits have been dialled and a connection is to be established.

Normally, it is possible to determine the total amounts of digits in a B-number before all digits have been dialled—so called B-number analysis. For example, a B-number dialled in Stockholm starting with “719” has totally seven digits while a B-number starting with “89” has totally six digits and a number dialled in Sweden starting with “001877” is a US New York number with totally thirteen digits.

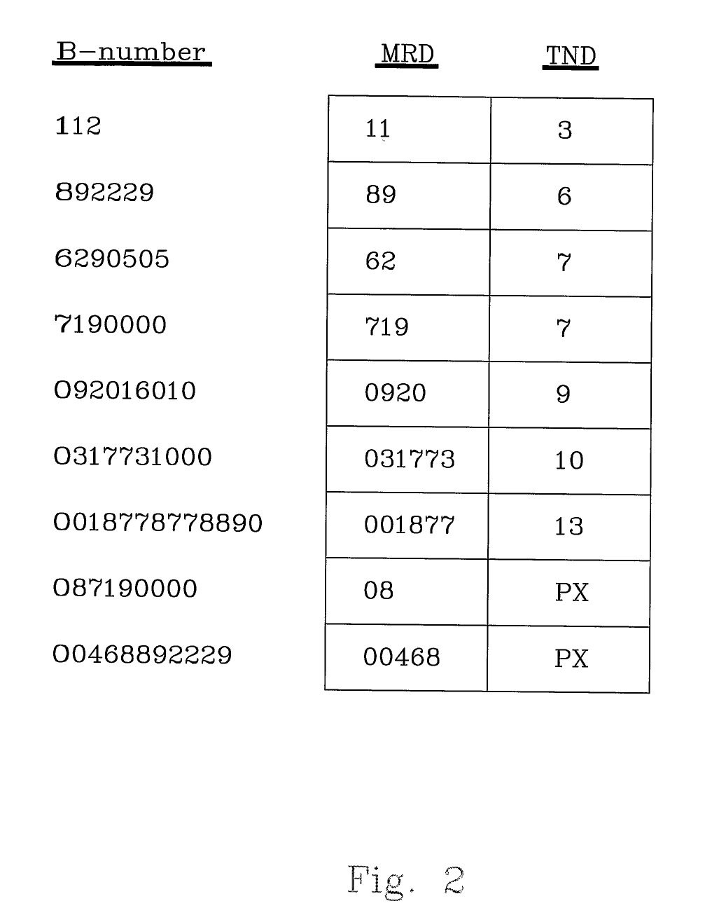

FIG. 2 discloses the contents of the database DB from FIG. 1. The DB comprises a list MRD of records 11, 89, 62, 719, 0920, 031773, 001877, 08, 00468 that cover possible beginnings of B-numbers 112, 892229, 6290505, 7190000, 092016010, 0317731000, 0018778778890, 087190000, 00468892229. Each record points either to a numeral 3, 6, 7, 7, 9, 10, 13 in a column TND that represents the total numbers of digits in the B-number or to a prefix PX that indicates that so far received digits are to be neglected. The purpose of the prefix is to avoid multiply storage of the “same” number in the database. To maximize the number of matches with dialled B-numbers the database is preferably regularly updated. A relatively small database with only a few hundreds of records covers in this way approximately over 98% of all phone calls.

A method according to the first embodiment of the invention will now be described. References that are used in the description below can be found in FIGS. 1 and 2. The method will show rapid dialling in a telecommunication system that requires termination indication of a B-number, to establish a connection. The telephone set POTS communicating with the system is however without ability to indicate such termination. The method comprises the following steps:
An A-subscriber lifts the handset of the telephone set POTS and starts to dial a number to a B-subscriber, digit by digit 0-0-1-8-7-7-8-7-7-8-8-9-0.
Each dialled digit is transferred from the POTS to the Home Base Station HBS.
Each dialled digit is decoded from DTMF signalling to a digital number in the Home Base Station HBS and transferred in the Broadband Access Network BAN from the HBS to the Home Base Station Controller HBSC.
A B-value 001877 is composed of the so far dialed digits and stored in the HBSC each time a digit has been dialed.
The composed B-value 001877 is compared with records 11,89,62,719,0920,031773,001877,08,00468 in the list MRD of records stored in the database DB.
Conformity is found between the composed B-value 001877 and a record 001877 in the list MRD. The found record points to a numeral “13” that represents the total number of digits in the complete B-number.
Connection between the A-subscriber and the B-subscriber is established when thirteen “13” digits has been received by the Home Base Station Controller HBSC.

As a variation of the above example the A-subscriber instead of dial the B-number digit-by-digit, the A-subscriber just press one button and get access to a stored B-number in the POTS. The same inventive idea is applicable in this case.

A method according to a second embodiment of the invention will now be described. References that are used in the description below can be found in the FIGS. 1 and 2. The method will show rapid dialling when the dialled B-number starts with an area-code and the prefix is used. The method comprises the following steps:
An A-subscriber lifts the handset of the POTS and starts to dial a number to a B-subscriber, digit by digit 0-8-7-1-9-0-0-0-0.
Each dialled digit is transferred from the POTS to the Home Base Station HBS.
Each dialled digit is decoded and transferred in the Broadband Access Network BAN from the Home Base Station HBS to the Home Base Station Controller HBSC.
A B-value 08 is composed of the so far dialed digits and stored in the HBSC.
The composed B-value 08 is compared with records 11,89,62,719,0920,031773,001877,08,00468 in the list MRD of records stored in the database DB.
Conformity is found between the composed B-value 08 and a record 08 in the list MRD. The found record points to the prefix PX that indicates that so far dialed digits are to be ignored.
So far stored digits in the HBSC, i.e. “0” and “8”, are deleted from the HBSC.
A B-value 719 is composed of the so far dialed digits, not including the ignored digits 08, and stored in the HBSC.
The composed B-value 719 is compared with records 11,89,62,719,0920,031773,001877,08,00468 in the list MRD of records stored in the database DB.
Conformity is found between the composed B-value 719 and a record 719 in the list MRD. The found record points to a numeral “7” that represents the total number of digits in the complete B-number, not counting the ignored digits 08.
Connection between the A-subscriber and the B-subscriber is established when seven “7” digits has been received (deleted digits “08” are uncounted) by the Home Base Station Controller HBSC.

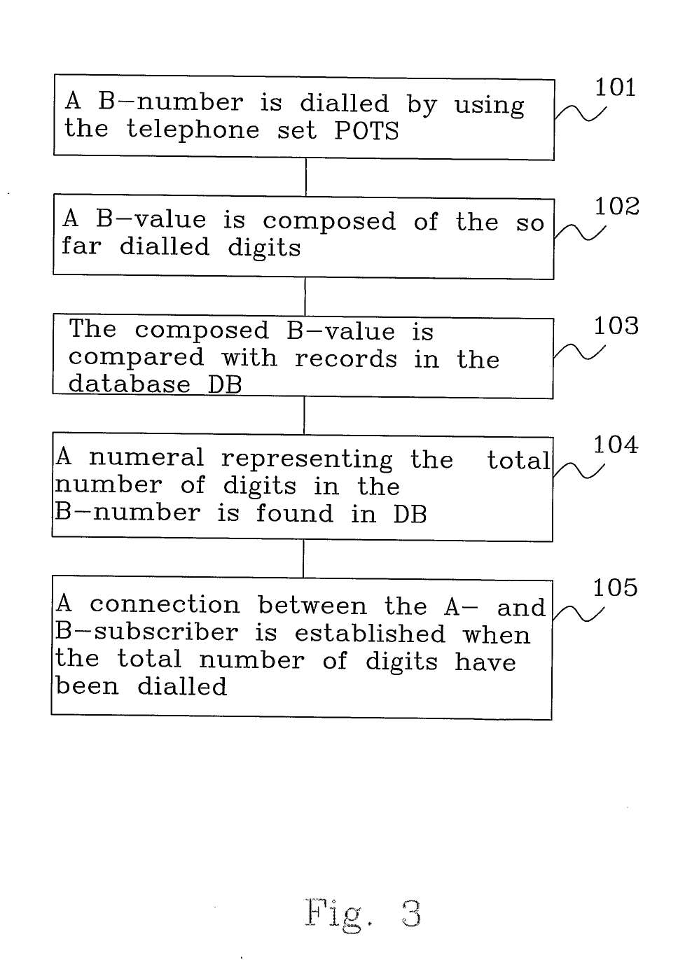

In FIG. 3 some essential steps of the described methods are shown in a flow chart. The flow chart is to be read together with the earlier shown figures. The steps are:
A B-number 0-0-1-8-7-7-8-7-7-8-8-9-0 is dialled using the telephone set POTS. A block 101 discloses this step in FIG. 3.
A B-value 001877 is composed of the so far dialed digits and stored in the HBSC. A block 102 discloses this step in FIG. 3.
The composed B-value 001877 is compared with records 11,89,62,719,0920,031773,001877,08,00468 in the list MRD of records stored in the database DB. A block 103 discloses this step in FIG. 3.
Conformity is found between the composed B-value 001877 and a record 001877 in the list MRD. The found record points to a numeral “13” that represents the total number of digits in the complete B-number. A block 104 discloses this step in FIG. 3.
Connection between the A-subscriber and the B-subscriber is established when thirteen “13” digits has been received by the Home Base Station Controller HBSC. A block 105 discloses this step in FIG. 3.

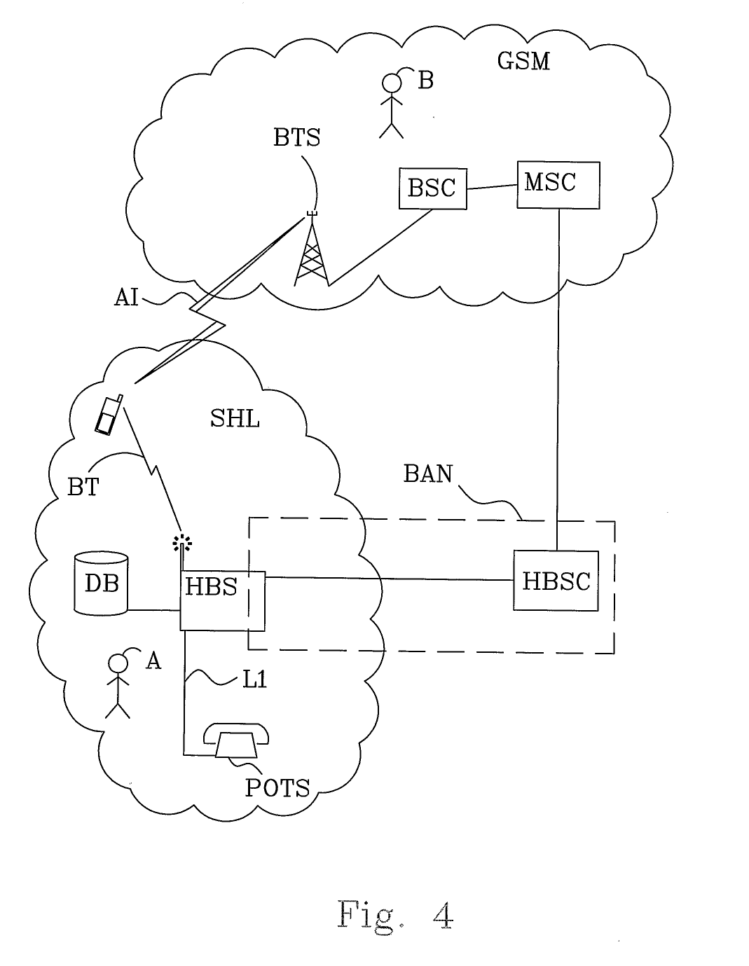

A method according to a third embodiment of the invention will now be described together with FIG. 4. The method will show rapid dialling in a telecommunication system when the database is located in the Subscriber's Home Location SHL instead of in the Broadband Access Network BAN. The method comprises the following steps:
The A-subscriber lifts the handset of the telephone set POTS and starts to dial a number to the B-subscriber, digit by digit 0-0-1-8-7-7-8-7-7-8-8-9-0.
Each dialled digit is transferred from the POTS to the Home Base Station HBS.
A B-value 001877 is composed of the so far dialed digits and stored in the Home Base Station HBS.
The composed B-value 001877 is compared with records 11,89,62,719,0920,031773,001877,08,00468 in the list MRD of records stored in the database DB.
Conformity is found between the composed B-value 001877 and a record 001877 in the list MRD. The found record points to a numeral “13” that represents the total number of digits in the complete B-number;
When a number of digits representing the numeral “13” has been received each dialled digit is decoded and transferred in the Broadband Access Network BAN from the Home Base Station HBS to the Home Base Station Controller HBSC.
When all dialled digits have been transferred in the Broadband Access Network BAN from the Home Base Station HBS to the Home Base Station Controller HBSC, an emulated “CALL” signal is transferred from the Home Base Station HBS to the Home Base Station Controller HBSC. The emulated “CALL” signal represents an indication of termination of the B-number.
Connection between the A-subscriber and the B-subscriber is established.

As a variation of the third embodiment, instead of waiting to transfer digits from HBS to HBSC until all thirteen digits have been received to the HBS, digits are transferred continuously to the HBSC. As another variation to the third embodiment, instead of transfer the emulated “CALL” signal from the HBS to the HBSC, a timer in the HBSC resets and starts each time a new digit is received to the HBSC. The connection is established when the predefined “short” time has elapsed. The predefined time is slightly more than the time between two consecutive digits and the lapse will consequently happen after the last digit has been received.

Different variations are possible within the scope of the invention. The network shown in the examples can be of another type than the examples disclosed mobile-at-home network, for example 3G, VOIP, SIP, H.323 or a cable TV network like DOCSIS. In another variation, the database can be located for example within the used telephone set or within Customer Premises Equipment. The broadband access network can also be of various types. The B-value can for example be stored in the MSC in the above mobile-at-home example.

The invention is in other words not limited to the above described and in the drawings shown embodiments but can be modified within the scope of the enclosed claims.

1. A method for rapid dialling in a telecommunication system that requires an indication of a B-number termination to establish a connection, which system is communicating with a telephone set without ability to indicate such termination, the method comprising the following steps:
dialing a B-number using said telephone set;
comparing a B-value composed of the so far dialed digits with a list of records stored in a database in the system; and
matching the composed B-value and a record in said list, which points to a numeral representing the total number of digits in the complete B-number;

2. The method for rapid dialling in a telecommunication system according to claim 1, further comprising the steps of:
comparing the B-value composed of the so far dialed digits with a list of records stored in the database in the system;
matching the composed B-value and a record in the list, which points to a prefix indicating that the so far dialed digits are to be ignored.

3. The method for rapid dialling in a telecommunication system according to claim 1 whereby the telephone set is connected to a Home Base Station that is further connected to a network via a Home Base Station Controller wherein a database is connected to the Home Base Station Controller which method comprises the following further steps:
storing the composed B-value in the Home Base Station Controller connected database;
establishing a connection when a number of digits corresponding to said numeral has been dialed.

4. The method for rapid dialling in a telecommunication system according to claim 1 whereby the telephone set is connected to a Home Base Station that is further connected to a network via a Home Base Station Controller wherein a database is connected to the Home Base Station, which method comprises the following further steps:
storing the composed B-value in the Home Base Station connected database;
transferring each dialled digit from the Home Base Station to the Home Base Station Controller when a number of digits corresponding to said numeral has been dialed.

5. The method for rapid dialling in a telecommunication system according to claim 4 further comprising the following steps:
transferring an emulated “CALL” signal from the Home Base Station to the Home Base Station Controller;
establishing a connection when the emulated “CALL” signal has been received.

6. The method for rapid dialling in a telecommunication system according to claim 4 further comprising the following steps:
resetting/starting a timer in the Home Base Station Controller each time a digit is received;
establishing a connection after the lapse of a predefined time of the timer.

7. An arrangement for rapid dialling in a telecommunication system that requires an indication of a B-number termination to establish a connection, which system is communicating with a telephone set without ability to indicate such termination comprising:
means for composing a B-value of the so far dialed digits;
means for comparing the composed B-value with a list of records stored in a database in the system;
means for matching the composed B-value and a record in said list the record pointing to a numeral representing the total number of digits in the complete B-number.

8. The arrangement for rapid dialling in a telecommunication system according to claim 7, which arrangement comprises:
means for ignoring the so far dialed digits.

9. The arrangement for rapid dialling in a telecommunication system according to claim 7 whereby the telephone set is connected to a Home Base Station connected to a network via a Home Base Station Controller, whereby the database is connected to the Home Base Station Controller, which arrangement further comprises:
means for storing the composed B-value in the Home Base Station Controller;
means for establishing a connection when a number of digits corresponding to said numeral has been dialed.

10. The arrangement for rapid dialling in a telecommunication system according to claim 7 whereby the telephone set is connected to a Home Base Station connected to a network via a Home Base Station Controller, whereby a databases is connected to the Home Base Station, which arrangement further comprises:
means for storing the composed B-value in the Home Base Station;
means for transferring each dialled digit from the Home Base Station to the Home Base Station Controller.

11. The arrangement for rapid dialling in a telecommunication system according to claim 10 which method further comprises:
means for transferring an emulated “CALL” signal from the Home Base Station to the Home Base Station Controller;
means for establishing a connection when the emulated “CALL” signal has been received.

12. The arrangement for rapid dialling in a telecommunication system according to claim 10 which arrangement further comprises a timer in the Home Base Station Controller and means to establish a connection after the lapse of a predefined time of the timer.
